(19) United States
(12) Patent Application Publication
(10) Pub. No.: US 2008/0070567 A1
(43) Pub. Date: Mar. 20, 2008

(54) Portable Communication Device Having a Scent Emitting Compound

(75) Inventor: John T. Sadler, Wake Forest, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/531,716

(22) Filed: Sep. 14, 2006

(51) Int. Cl. H04Q 7/20

(52) U.S. Cl. 455/425

(57) ABSTRACT

A portable wireless communication device comprises a housing, a transceiver within the housing, and a scented compound associated with the housing. The transceiver permits a user to communicate with one or more remote parties via a base station subsystem in a wireless communication network. The scented compound emits a scent whenever the scented compound is activated. Activation may occur responsive to a user keypress on a keypad of the portable wireless communication device, or to radiated heat that exceeds a predetermined temperature.

### BACKGROUND

The present invention relates generally to portable wireless communication devices, and particularly to portable wireless communication devices that emit a scent.

Consumers often seek innovative features and new functionality when purchasing portable wireless communication devices. Of course, consumer interest in what was once new and innovative often wanes quickly. Thus, manufacturers and service providers sometimes struggle to keep abreast of consumer demand. Those that cannot get new features to market fast enough may find themselves losing market share. Therefore, manufacturers could benefit if they offered new features that enticed the user to purchase their portable wireless communication devices instead of their competitor's devices.

One of the most popular and widely used features continues to be the ability to converse with a remote party. Typically, users purchase blocks of time in minutes for a flat fee from service providers. Blocks of time associated with a greater number of minutes usually cost more than those blocks associated with a fewer number of minutes. Therefore, service providers could also benefit from features that entice users to use their portable wireless communication devices more often and for longer periods of time than they normally would.

### SUMMARY

A portable wireless communication device such as a cell phone comprises a housing, a transceiver circuit in the housing, and a compound associated with the housing that emits a scent when activated. The scent may be, for example, a fragrant odor that is detectable by the human olfactory sense.

In one embodiment, the compound comprises a heat-activated scented adhesive layer disposed within the housing. The scented adhesive layer may be used to adhere a label to an electronic component, or to a shield that electrically shields one or more electronic components. The electronic components radiate heat during use. Once the heat exceeds a predetermined temperature, the scented adhesive layer emits the scent. The scent may then permeate the housing of the portable wireless communication device. When the components cool below the predetermined temperature, the scented adhesive layer ceases to emit the scent.

In other embodiments, the compound comprises a scented adhesive layer applied to one or more operational layers of a keypad assembly together. In these embodiments, the scented adhesive layer emits a scent responsive to the user pressing one or more keys on the keypad. In one particular embodiment, pressing a key causes an activator to contact the scented adhesive layer, which then emits the scent responsive to this contact. In another particular embodiment, pressing a key displaces air over the scented adhesive layer. The displaced air mixes with the scent and permeates the housing of the portable wireless communications device.

### BRIEF DESCRIPTION OF THE DRAWINGS

FIG. 1 is a block diagram that illustrates some of the component parts of a portable wireless communication device configured according to one embodiment of the present invention.

FIG. 2 is a perspective view of a portable wireless communication device configured according to one embodiment of the present invention.

FIG. 3 illustrates a surface of a printed circuit board (PCB) disposed within a housing of a portable wireless communication device configured according to one embodiment of the present invention.

FIG. 4A is a sectional view of one heat-activated embodiment of the present invention.

FIG. 4B is a sectional view of another heat-activated embodiment of the present invention.

FIG. 5 is a side view that illustrates a portable wireless communication device configured according to another heat-activated embodiment of the present invention.

FIG. 6 is an exploded view of a keypad assembly suitable for use according to one embodiment of the present invention.

FIGS. 7A-7B are magnified sectional views of the keypad assembly illustrating one pressure-sensitive embodiment of the present invention.

FIG. 8 illustrates one of the operational layers of the keypad assembly according to one embodiment of the present invention.

FIGS. 9A-9B are magnified sectional views of the keypad assembly illustrating another embodiment of the present invention.

FIG. 10 is a perspective view of a portable wireless communication device configured according to another embodiment of the present invention.

### DETAILED DESCRIPTION

The present invention is directed to a portable wireless communication device configured to emit a scent. A scent may be, for example, a distinctive odor or fragrant aroma that may be detected by the olfactory senses of a human, an animal, or an insect. The scent may be pleasant or unpleasant. Examples of such scents include, but are not limited to, odors or aromas that the user equates to any of a variety of perfumes, flowers, spices, and the like. A scent may also be a pheromone. Pheromones are odors produced by living organisms and are used for communication between like organisms. While a person, for example, may not be able to detect a pheromone as a “smell,” they are detectable by the olfactory senses nonetheless, and thus, are expressly included within the meaning of the term “scent” as that term is used herein.

According to one embodiment of the present invention, a heat-sensitive scented compound is disposed within a housing of device 10 proximate the internal circuitry of device 10. The internal circuitry of device 10, which may comprise one or more electronic components, radiates heat during operation. By way of example, the circuitry may radiate heat whenever a user places or receives a call to a remote party. One embodiment of the present invention advantageously employs this radiated heat to cause the heat-sensitive scented compound to emit the scent. The scent permeates the housing of device 10 through natural openings in the housing, and/or through one or more specially-formed openings in the housing.

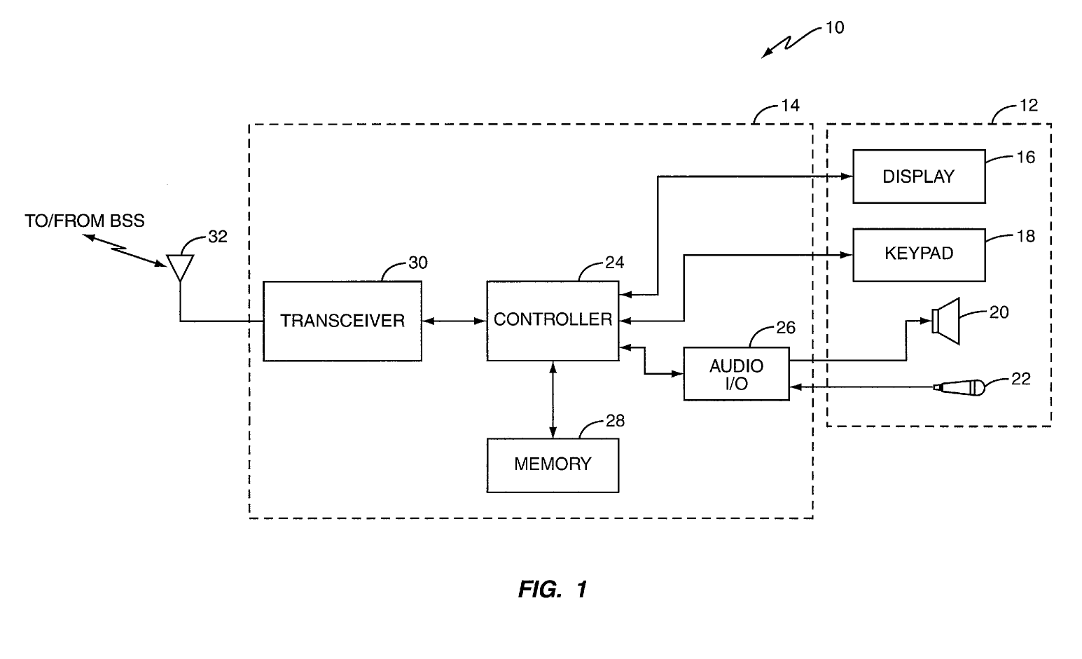

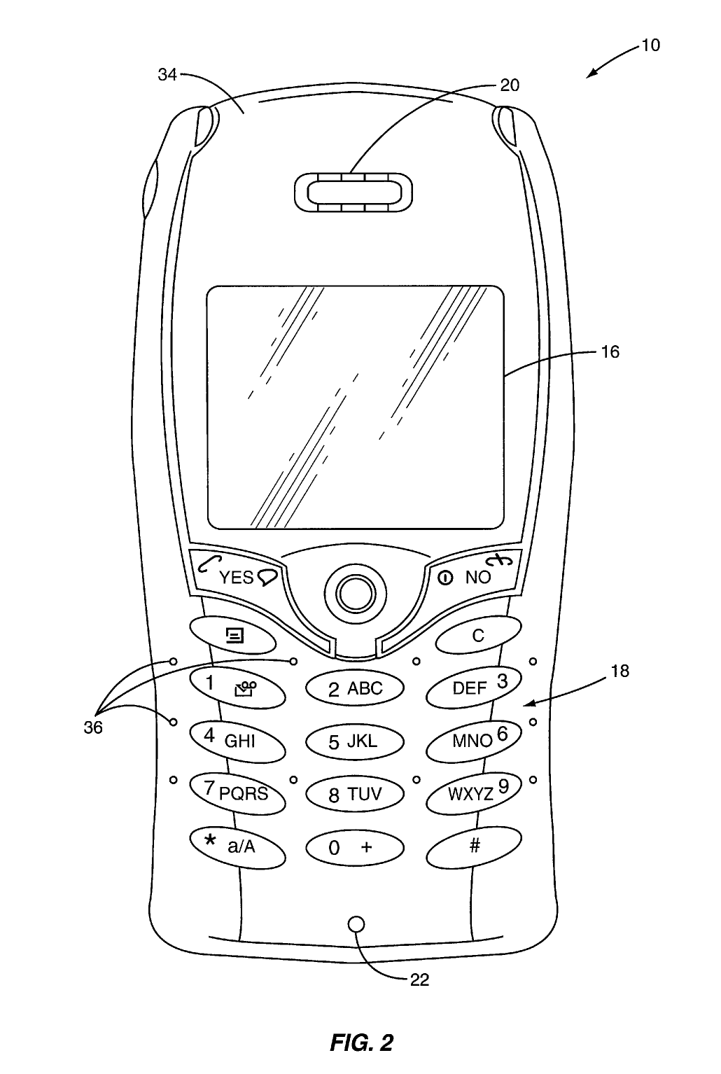

FIGS. 1 and 2 illustrate a portable wireless communication device 10 suitable for use with the present invention. In the specification and figures, the portable wireless communication device 10 is specifically embodied as a cellular telephone; however, this is for illustrative purposes only. Those skilled in the art should appreciate that the present invention may be embodied in other types of portable consumer electronics devices including, but not limited to, a Portable Digital Assistant (PDA), a palmtop or laptop computer, or a communication module included within a computer, a satellite phone, or other type of portable communication device.

Portable wireless communication device 10 comprises a user interface (UI) 12 and circuitry 14 disposed within a housing 34. UI 12 includes a display 16, a keypad 18, a speaker 20, and a microphone 22. Circuitry 14 comprises a controller 24, an audio I/O circuit 26, memory 28, and a transceiver circuit 30 connected to an antenna 32. The operation of the UI 12 and the circuitry 14 with respect to communicating with a remote party is well known in the art. Therefore, this functionality is not described in detail herein. It is sufficient for the purposes of the present invention to understand that the device 10 is a fully functional cellular radio device capable of operating according to any known standard. Such standards include, but are not limited to, Global System for Mobile Communications (GSM), Universal Mobile Telecommunication System (UMTS), TIA/EIA-136, Code Division Multiple Access (CDMA), cdmaOne, cdma2000, and Wideband CDMA.

As previously stated, one embodiment of the present invention advantageously employs heat radiated by the circuitry 14 to activate a heat-sensitive scented compound. Particularly, the scented compound emits the scent while the radiated heat is at a temperature that reaches or exceeds a predetermined threshold temperature. The scent may permeate the device 10 through natural openings in the housing of device 10, and/or through one or more specially-formed perforations 36 in the housing of device 10.

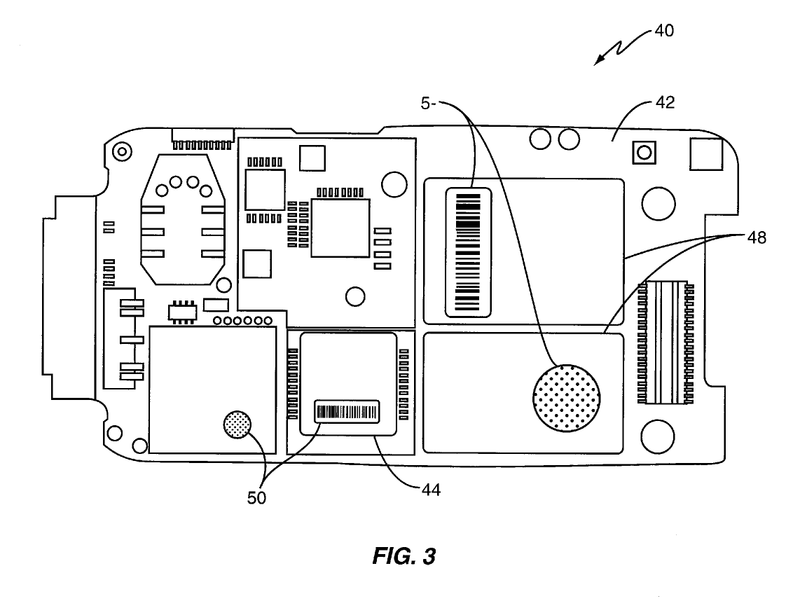

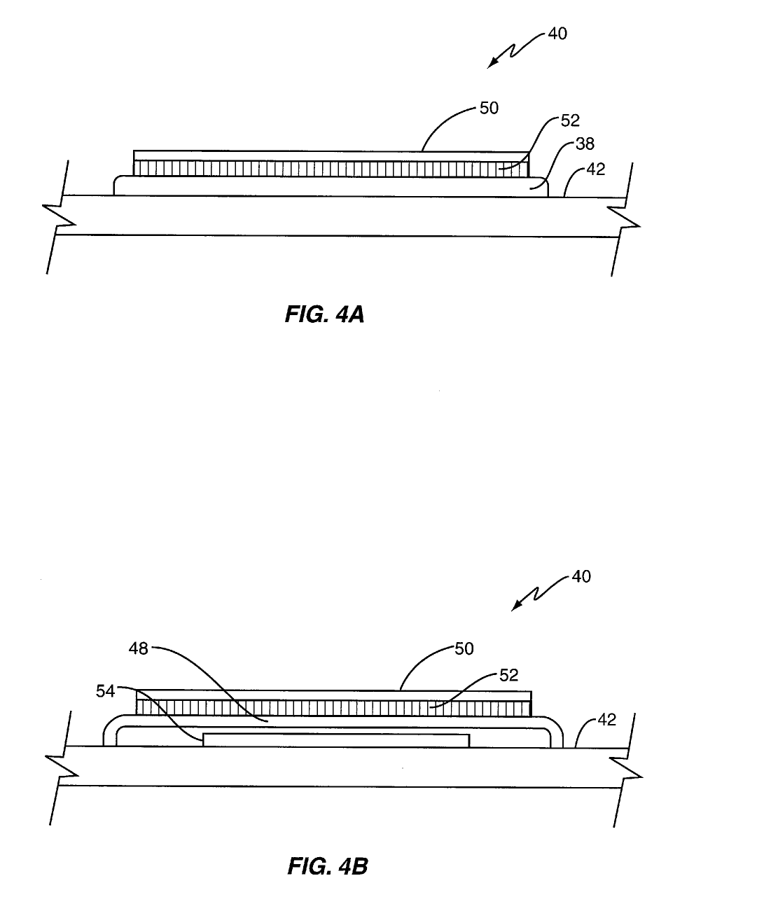

FIGS. 3-4 illustrate some of heat-activated embodiments contemplated by the present invention. In these embodiments, a printed circuit board (PCB) 40 is disposed within the housing 34 of device 10. PCB 40 typically includes one or more electronic components soldered or disposed on a surface 42 of PCB 40. Such components include, but are not limited to, any of a variety of amplifiers, converters, and microprocessors. In this embodiment, for example, PCB 40 includes a signal-processing chip 44. As is known in the art, one or more shields 48 may be used to electrically shield some of these electronic components on circuitry 14 to mitigate or prevent the effects of electronic interference within housing 34.

The signal-processing chip 44 and/or the shields 48 may include labels 50 that carry various information about the device 10 or the components. Typically, a manufacturer attaches the labels 50 to the signal-processing chip 44 and/or shields 48 during the manufacturing process for identification purposes, or to indicate the successful completion of a given quality control process. According to one embodiment of the present invention, an adhesive used to apply the label 50 to the signal-processing chip 44 and/or shields 48. The adhesive may comprise a heat-activated scented adhesive compound that emits a scent whenever the heat radiated by the signal-processing chip 44 and/or shields 48 reaches or exceeds a predetermined temperature.

FIG. 4A illustrates one embodiment, where a heat-activated scented adhesive compound 52 adheres a label 50 directly to an external surface of the signal-processing chip 44. FIG. 4B illustrates another embodiment where a heat-activated scented adhesive compound adheres label 50 directly to an exterior surface of a shield 48 that substantially covers a portion of a transceiver circuit 54. During periods of little or no use, the signal-processing chip 44, the shield 48, and the scented adhesive compound 52 remain below a predetermined temperature. Below such temperatures, the scented adhesive compound 52 remains inactive such that it does not emit a scent. During use, however, the signal-processing chip 44 and/or the shield 48 generate and radiate heat. Once the signal-processing chip 44 and/or the shield 48 reaches or exceeds a predetermined temperature, the scented adhesive compound 52 is activated and releases a scent.

The scented adhesive compound 52 may comprise any adhesive compound known in the art that is mixed or combined with one or more chemicals or compositions that release a scent or odor at a given temperature. In one embodiment, for example, an adhesive compound is mixed with any of a variety of commercially available fragrant essential oils. The oils may be extracted from natural objects such as flowers, artificially developed by mixing a plurality of oils or other fragrant substances, or synthetically produced using any means known in the art. In other embodiments, these oils are simply sprayed or spread over a surface of an adhesive compound prior to affixing the label 50 to the signal-processing chip 44 and/or the shield 48.

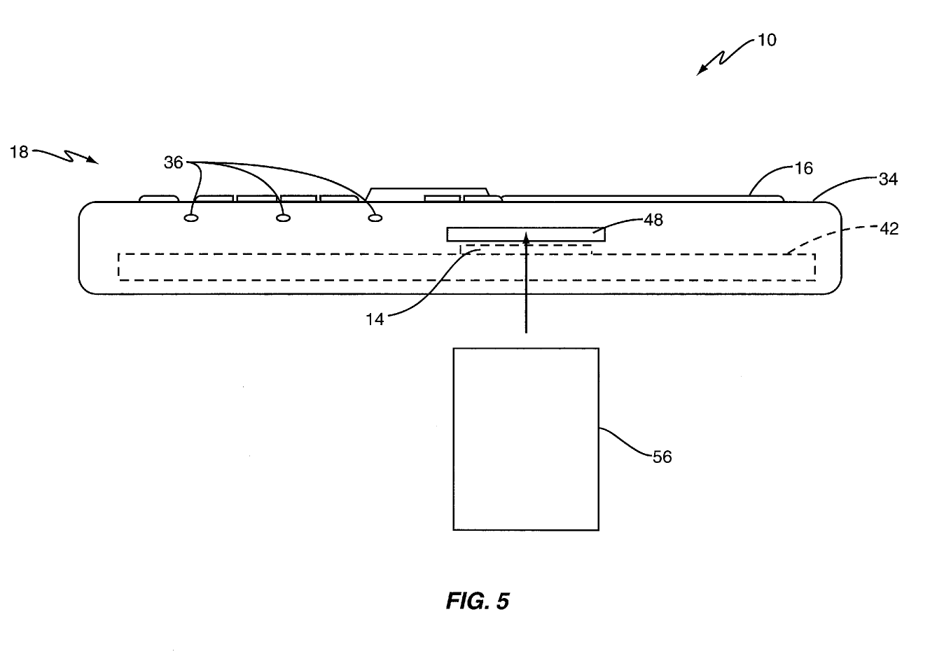

Those skilled in the art should note that the present invention does not require direct contact with an electronic component to activate heat-sensitive scented compounds. Nor does the present invention require that the heat-sensitive scented compound be an adhesive. FIG. 5, for example, illustrates another heat-activated embodiment wherein a non-adhesive scented tablet 56 inserts into a slot or opening 58 formed in the housing 34. The scented tablet 56 may comprise a substantially rigid cake-like member having any of a variety of commercially available heat-sensitive fragrant oils. The opening 58 may be formed such that when the scented tablet 56 is inserted, it is proximate one or more electronic components of circuitry 14 without actually contacting the components. The heat radiated by the circuitry 14 may activate the scented tablet 56 as previously described. The released scent may then permeate through natural openings in the housing 34 and/or through the one or more perforations 36. This particular embodiment offers an advantage in that a user may change the scented tablet 56 with any of a variety of different scented tablets 56 as needed or desired.

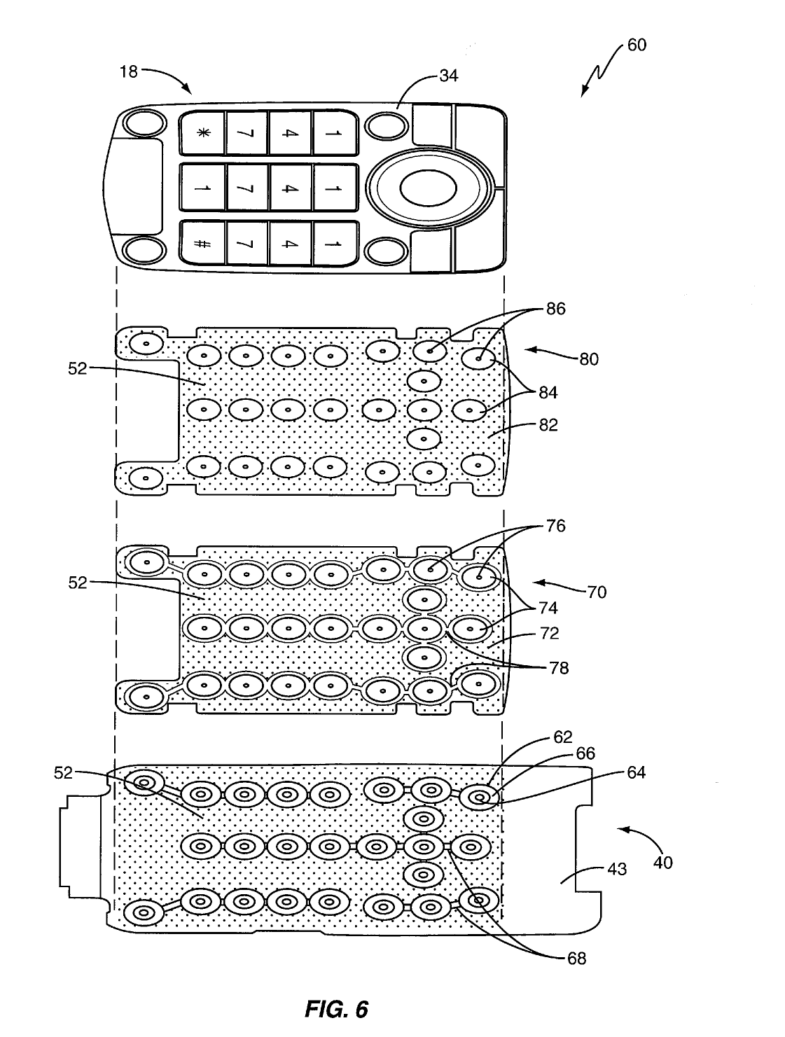

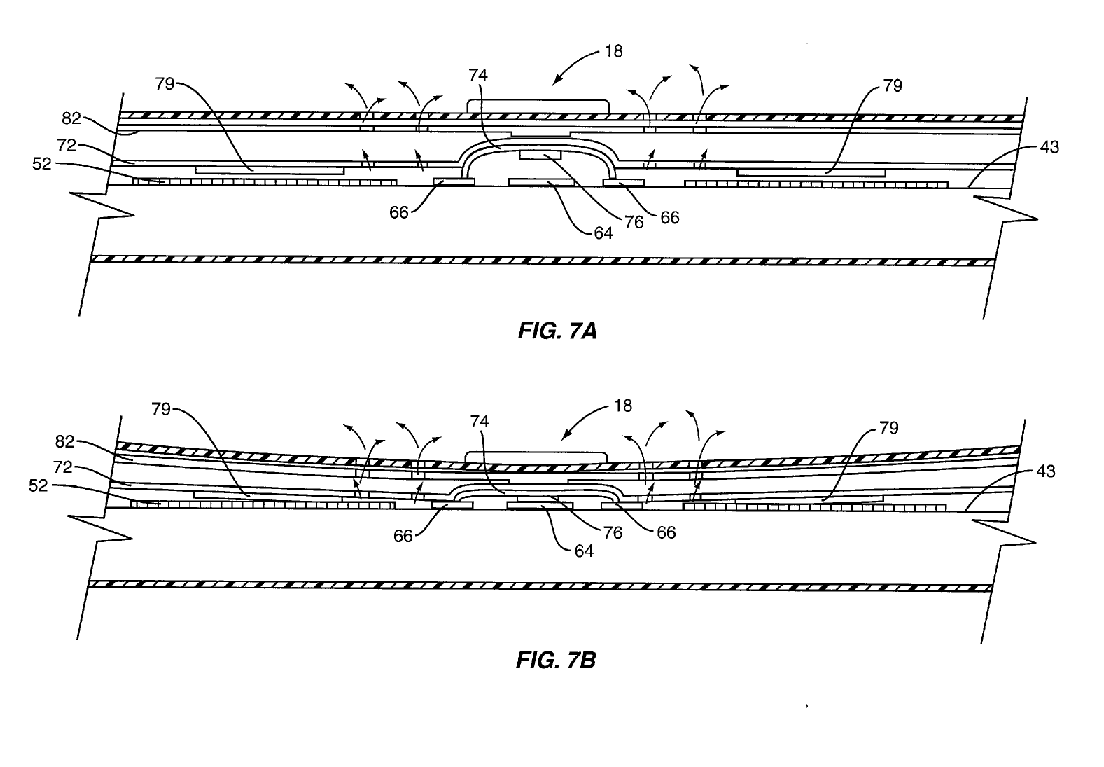

FIGS. 6-7 illustrate an alternate embodiment wherein a scented adhesive compound 52 is used to adhere multiple layers of a keypad assembly 60 together. In this embodiment, the scented adhesive compound 52 is pressure-sensitive such that it releases a scent whenever a user presses a key on the keypad 18.

In this embodiment, the scented adhesive compound 52 contains a plurality of gelatinous or plastic globules, each of which may be a few microns in diameter. Each globule encapsulates a small amount of fragrant oil or other scent-bearing substance. Whenever the user presses a key, an activator contacts the scented adhesive compound 52. This contact causes one or more of these globules rupture and release the scent. In some embodiments, a surface of the activator is slightly knurled or roughened such that it engages the scented adhesive compound 46 in frictional contact. This frictional contact ruptures one or more of the globules to release the scent

Keypad assembly 60 comprises the PCB 40, a dome cover sheet 70, a mylar cover sheet 80, and the keypad 18. The scented adhesive compound 52 may be used to adhere each layer to one or more adjacent operational layers. PCB 40 includes a surface 43 that, in this embodiment, is opposite surface 42. PCB surface 43 includes a plurality of conductive contacts 62 that operate as part of a switch to register key presses by the user. One or more contacts 62 may connect to adjacent contacts via a conductive trace 68. Each contact 62 comprises an inner conductive trace 64 that is insulated from and concentrically oriented with respect to an outer conductive trace 66.

The dome cover sheet 70 comprises a plurality of conductive dome switches 74 adhered to a perforated sheet 72. The dome cover sheet may be disposed between the PCB 40 and the mylar cover sheet 80. Each dome switch 74 is generally concave shaped and is positioned on the perforated sheet 72 such that it aligns with the inner and outer conductive traces 64, 66 of a single contact 62. Particularly, the peripheral edge of a given dome switch 74 aligns with, and remains in contact with, a corresponding outer conductive trace 66 on PCB surface 43. A tip 72 formed on the interior of the dome switch 74 aligns with and is spaced above the inner conductive trace 64. When a user presses a key, the corresponding dome switch 74 deforms such that the tip 76 is urged into contact with the inner conductive trace 64. Upon contact, both the tip 76 and the peripheral edges of the dome switch 74 contacts the inner and outer conductive traces 64, 66, respectively, to complete a circuit. This circuit completion is then registered as a key press.

The mylar cover sheet 80 is disposed between the dome cover sheet 70 and the keypad 18. The mylar cover sheet 80 may adhere to both the dome cover sheet 70 and the keypad 18 using the scented adhesive compound 52. Mylar cover sheet 80 may comprise a perforated sheet 82 formed to include a plurality of flexible members 84. Each flexible member 84 may include a tip 86 that is forced into contact with an apex of a corresponding dome switch 74 whenever a user presses a key on the keypad 18. This contact causes the dome switch 74 to deform as previously described.

According to one pressure-activated embodiment of the present invention, the dome cover sheet 70 comprises an activator 79 that frictionally engages the scented adhesive compound 52 whenever the user presses a key. This frictional contact on the scented adhesive compound 52 ruptures one or more of the globules in the scented adhesive compound 52, and causes it to release a scent.

FIGS. 7A-7B illustrate an exemplary keypad assembly 60 in cross-section. For clarity, FIGS. 7A-7B illustrate a magnified view of a single dome switch 74; however, those skilled in the art will appreciate that these figures and corresponding description are equally applicable to the other dome switches 64.

As seen in FIGS. 7A-7B, the dome sheet 70 includes one or more activators 79 formed on the perforated sheet 72. As the dome switch 74 is deformed into contact with the inner conductive trace 64 (FIG. 7B), the activator 79 is forced into contact with a portion of the scented adhesive compound 52 that adheres the dome cover sheet 70 to the PCB 40. This frictional contact with the scented adhesive compound 52 releases its corresponding scent. The scent may waft its way to the housing 34 via the perforations formed in the dome and mylar cover sheets 70, 80, and exit the housing 34 as previously described.

The previous embodiment disposes the scented adhesive compound 52 between the dome cover sheet 70 and the PCB surface 43. However, those skilled in the art should appreciate that the scented adhesive layer 52 may adhere any of the layers of keypad assembly 60 together. Thus, the activator 79 is not confined only to being formed on the dome cover sheet 70. In other embodiments, the mylar cover sheet 80 includes the activator 79 that frictionally contacts and activates the scented adhesive compound 52 disposed between the mylar cover sheet 80 and the dome cover sheet 70. Likewise, the keys on the keypad 18 could include the activator 79 to frictionally contact and activate a scented adhesive compound 52 disposed between the keypad 18 and the mylar cover sheet 80.

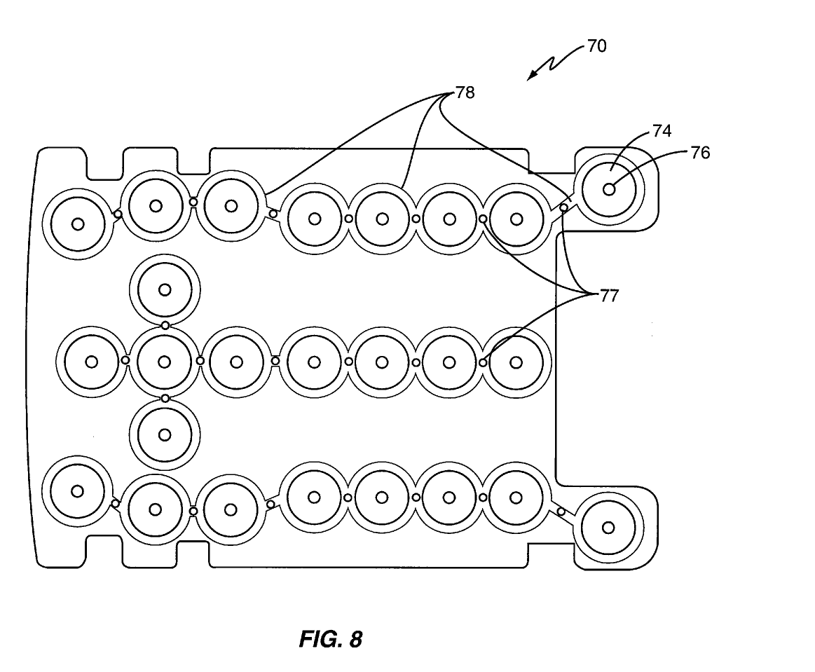

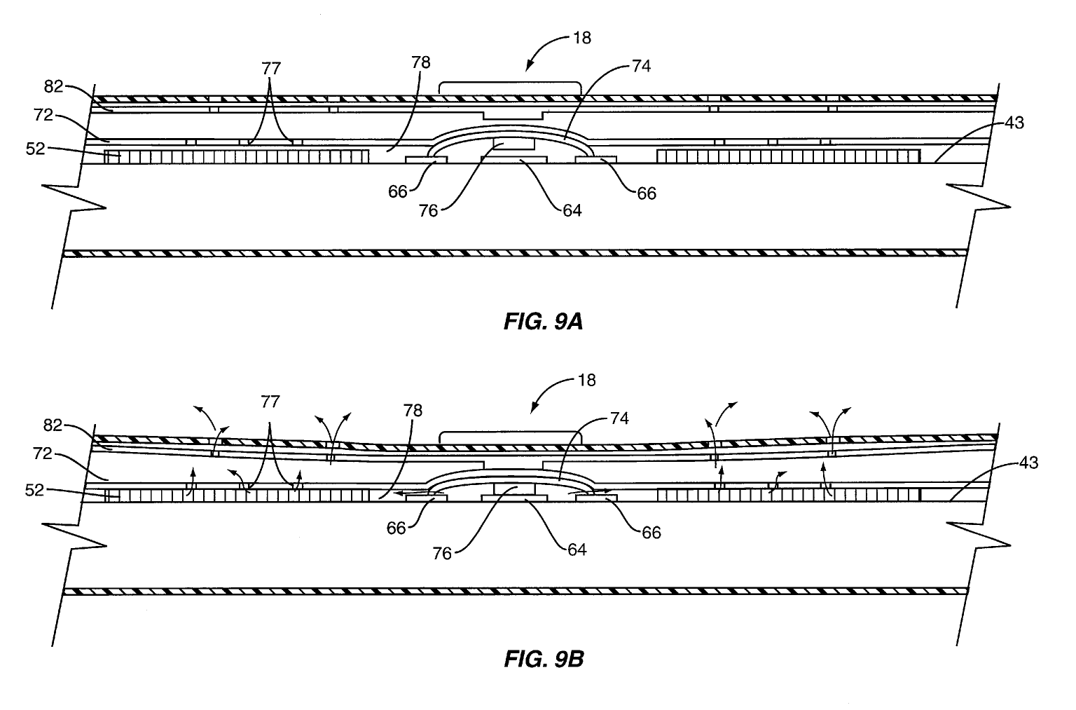

FIGS. 8-9 illustrate another embodiment wherein the scented adhesive compound 52 adheres the dome cover sheet 60 to the PCB surface 43. The scented adhesive compound 52 in this embodiment does not require heat or contact for activation. Rather, air is displaced from under the dome switch 74 whenever the user presses a key on the keypad 18. As air moves across the scented adhesive compound 52, small particles of the scented compound become entrained in the air flow.

As seen in FIG. 8, the dome cover sheet 70 may include one or more air passages 78 that interconnect one or more of the dome switches 74. A plurality of perforations 77 may be formed along one or more of the air passages 78. The air passages 78 form a space between the scented adhesive compound 52 and the underside of the dome cover sheet 70 (FIG. 9A). Air within these passages 78 contacts the scented adhesive compound 52 and thus, freely mixes with the scent.

As the dome switch 74 deforms in response to the user pressing a key, air is displaced from under the dome switch 74 and into the air passages 78 (FIG. 9B). This, in turn, forces the already-scented air within the passages 78 through the perforations 77 in the dome cover sheet 70, and through perforations in the mylar cover sheet 80. The scented air may then permeate through the housing 34 as previously described.

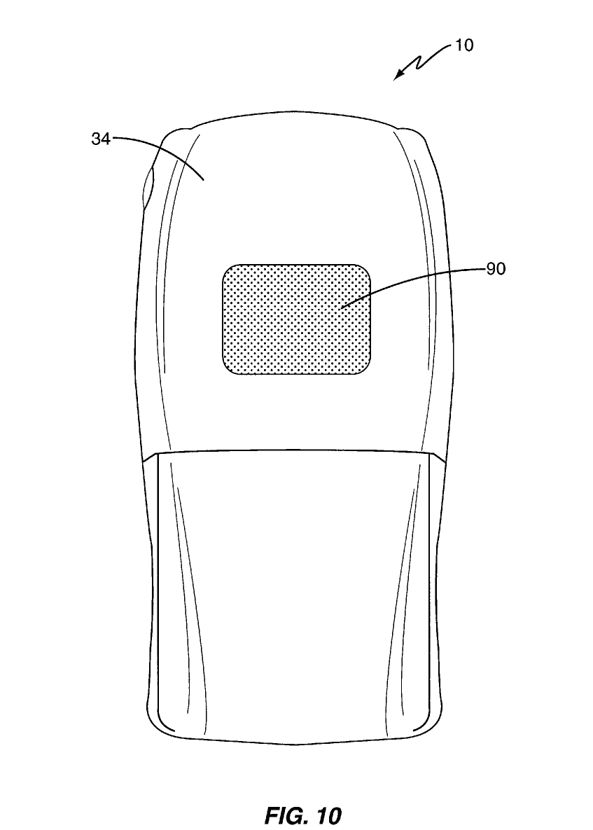

Those skilled in the art will readily appreciate that there are other methods by which to cause a scented compound to release its scent other than those methods explicitly described herein. FIG. 10, for example, illustrates an embodiment wherein a scented pad 90 is adhered to the exterior of the housing 34. The scented pad 90 comprises a fragrant oil or aroma that may be activated whenever the user holds the device. In one embodiment, the scented pad 90 releases a scent responsive to the user's body heat. In another embodiment, the scented pad 90 is pressure-activated. Particularly, whenever the user grasps or holds the device, one or more of the globules rupture to release the scent. When the user is not holding the device, the scented pad 90 could cease from emitting a scent.

In another embodiment, an electrical current is caused to flow through a scented compound disposed within the housing 34. By way of example, the current may be generated only during predetermined events such as whenever the user transmits or receives a signal, speaks into microphone 22, or listens to audible sound from speaker 20. In these embodiments, the current may be drawn from transceiver 28 or audio I/O circuit 26, for example, and applied to a scented compound. The current could heat the scented compound thereby causing it to release a scent.

It should be noted that the description discusses the scent as being a fragrant aroma pleasing to the user. However, the scent need not be readily recognized as an aroma by the user. For example, the globules previously described may contain small amounts of pheromones that the user's olfactory senses may detect without actually being able to “smell” a particular aroma. In addition, the scented compound may be impregnated with a chemical detectable by insects. In such cases, the user may or may not be able to “smell” an aroma.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A portable wireless communication device comprising:
a housing;
a transceiver circuit disposed within the housing configured to communicate signals with a wireless communication network; and
a scented compound associated with the housing and configured to emit a scent responsive to being activated.

2. The portable wireless communication device of claim 1 wherein the scented compound is activated by heat to emit the scent.

3. The portable wireless communication device of claim 2 wherein the scented compound is applied to an electronic component within the housing.

4. The portable wireless communication device of claim 2 wherein the scented compound is applied to shield within the housing.

5. The portable wireless communication device of claim 2 wherein the scented compound comprises a replaceable tablet that inserts into an interior of the portable wireless communication device through an opening formed in the housing.

6. The portable wireless communication device of claim 1 further comprising a keypad assembly, and wherein the scented compound adheres one or more layers of the keypad assembly together and is configured to release the scent responsive to a user keypress.

7. The portable wireless communication device of claim 6 wherein the keypad assembly comprises an activator that contacts the scented compound to cause the scented compound to release the scent.

8. The portable wireless communication device of claim 6 wherein the keypad assembly comprises one or more air passages, and wherein air displaced by the user keypress moves across the scented compound.

9. The portable wireless communication device of claim 1 wherein the scented compound comprises a scented adhesive.

10. The portable wireless communication device of claim 1 wherein the scent comprises a fragrant odor that permeates the housing when the scented compound is activated.

11. The portable wireless communication device of claim 1 wherein the scented compound is applied to an exterior of the housing.

12. A method of enticing a user to use a portable wireless communication device, the method comprising:
disposing a transceiver circuit within a housing of a portable wireless communication device, the transceiver circuit configured to communicate signals with a wireless communication network;
associating a scented compound with the housing, the scented compound being configured to emit a scent when activated; and
activating the scented compound to emit the scent.

13. The method of claim 12 wherein activating the scented compound comprises applying heat to the scented compound.

14. The method of claim 13 wherein associating a scented compound with the housing comprises applying the scented compound to an electronic component within the housing.

15. The method of claim 13 wherein associating a scented compound with the housing comprises applying the scented compound to a shield within the housing.

16. The method of claim 13 wherein associating a scented compound with the housing comprises inserting a replaceable tablet into an opening formed on the housing of the portable wireless communication device.

17. The method of claim 12 wherein associating a scented compound with the housing comprises adhering one or more layers of a keypad assembly together using the scented compound.

18. The method of claim 17 wherein activating the scented compound to emit the scent comprises contacting the scented compound with an activator associated with the keypad assembly responsive to a user keypress.

19. The method of claim 17 wherein activating the scented compound to emit the scent comprises displacing air over the scented compound responsive to a user keypress.

20. The method of claim 12 wherein the scented compound comprises a scented adhesive.

21. The method of claim 12 wherein the scent comprises a fragrant odor that permeates the housing when the scented compound is activated.

22. The method of claim 12 wherein associating a scented compound with the housing comprises applying the scented compound to an exterior of the housing.
